(19) United States
(12) Patent Application Publication
(10) Pub. No.: US 2026/0333379 A1
(43) Pub. Date: Oct. 22, 2026

(54) SYSTEMS AND METHODS FOR SEARCH SPACE SET DESIGN IN WIRELESS SYSTEMS

(71) Applicant: InterDigital Patent Holdings, Inc., Wilmington, DE (US)

(72) Inventors: Aata El Hamss, Laval (CA); Moon IL Lee, Melville, NY (US); Paul Marinier, Brossard (CA); Tao Deng, New York, NY (US); Remun Koirala, London (GB)

(73) Assignee: InterDigital Patent Holdings, Inc., Wilmington, DE (US)

(21) Appl. No.: 19/186,102

(22) Filed: Apr. 22, 2025

(51) Int. Cl. H04W 72/232; H04W 24/08

(52) U.S. Cl. CPC H04W 72/232; H04W 24/08

(57) ABSTRACT

A wireless transmit/receive unit (WTRU) may receive configuration information. The configuration information may include an indication of a first search space set and/or a second search space set. The first search space set may indicate first physical downlink control channel (PDCCH) candidates. The second search space set may indicate second PDCCH candidates. The WTRU may monitor at least one of the first PDCCH candidates. The WTRU may receive an indication that the second search space set is linked to the first search space set. The WTRU may monitor at least one of the second PDCCH candidates, for example based on the indication that the second search space set is linked to the first search space set. The WTRU may receive downlink control information (DCI) via one or more of the at least one of the first PDCCH candidates or the at least one of the second PDCCH candidates.

### BACKGROUND

Downlink control channels may be used to schedule data transmission and/or system information. Additionally, or alternatively, downlink control channels may be used to indicate control information, for example transmit power commands and/or group common signaling (e.g., dynamic TDD configuration). The reliability of downlink control channels may affect transmissions (e.g., uplink and/or downlink). In new radio (NR) for example, downlink control information (DCI) may be transmitted in a search space set. The search space set may be associated with a control resource set (CORESET).

A CORESET configuration may include a frequency resource configuration and/or a number of symbols. The search space set configuration may include PDCCH monitoring aspects. A CORESET may include multiple search space sets. Both CORESET and search space set may be semi-static configured. A wireless transmit/receive unit (WTRU) may monitor the configured search space sets, for example according to a semi-static configuration (e.g., monitoring periodicity and/or number of physical downlink control channel (PDCCH) candidates.

### SUMMARY

Systems and methods herein may include search space set design aspects, DCI transmissions, PDCCH transmissions, and/or dynamic linkage of multiple search space sets. A WTRU may determine to link a search space set to a (e.g., another) search space set, for example based on an indication from the network, for example a dynamic indication. The indication may include DCI and/or medium access control (MAC).

The WTRU may be configured to monitor a semi-persistent and/or aperiodic search space set, for example after the WTRU transmits an uplink signal/channel to the network. The uplink signal/channel may include a buffer status report (BSR), scheduling request (SR), and/or physical uplink control channel (PUCCH). The WTRU maya be configured with a PDCCH indication. The PDCCH indication may indicate that the WTRU should start monitoring one or more CORESET(s), for example from a pre-configured list of CORESET(s).

A WTRU may receive configuration information, for example from a network (e.g., base station). The configuration information may include an indication of a first search space set and/or a second search space set. The first search space set may indicate first PDCCH candidates. The second search space set may indicate second PDCCH candidates. The WTRU may monitor at least one of the first PDCCH candidates indicated by the first search space set. The WTRU may receive an indication (e.g., from the network) that the second search space set is linked to the first search space set. The WTRU may monitor at least one of the second PDCCH candidates indicated by the second search space set, for example based on the indication that the second search space set is linked to the first search space set. The WTRU may receive DCI, for example via one or more of the at least one of the first PDCCH candidates or the at least one of the second PDCCH candidates. The WTRU may receive the indication that the second search space set is linked to the first search space set in one or more of a DCI or a medium access control (MAC) transmission.

The indication that the second search space set is linked to the first search space set may include an indication of a subset of the second PDCCH candidates. The WTRU may monitor the subset of the second PDCCH candidates. The indication that the second search space set is linked to the first search space set may include an indication of a start time and/or a time duration. The WTRU may monitor the at least one of the second PDCCH candidates indicated by the second search space set at the start time and/or for the time duration. The WTRU may stop monitoring the at least one of the second PDCCH candidates indicated by the second search space set after the time duration. The WTRU may monitor (e.g., repeat monitoring) the at least one of the first PDCCH candidates indicated by the first search space set, for example after the time duration.

The indication that the second search space set is linked to the first search space set may include an identifier (ID) of the second search space set. The WTRU may determine that the second search space set is linked to the first search space set based on the identifier of the second search space set. The first search space set may be linked to the second search space set and to a third search space set. The third search space set may indicate third PDCCH candidates. The second PDCCH candidates may include a first subset of repeated first PDCCH candidates and/or the third PDCCH candidates may include a second subset of repeated PDCCH candidates. The configuration information may include an indication of the third search space set. The indication that the second search space set is linked to the first search space set may include an indication that the third search space set is linked to the first search space set. The WTRU may be preconfigured with a configuration indicating that the first search space set is linked to a third search space set. The indication that the second search space set is linked to the first search space set may include an indication to change the configuration to link the first search space set with the second search space set.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is an example of linked search space sets with the same number of PDCCH candidates.

FIG. 3 is an example of linked search space sets with a different number of PDCCH candidates.

FIG. 4 is an example of WTRU monitoring of one or more search spaces.

FIG. 5 is an example procedure of WTRU monitoring of one or more search space sets.

### DETAILED DESCRIPTION

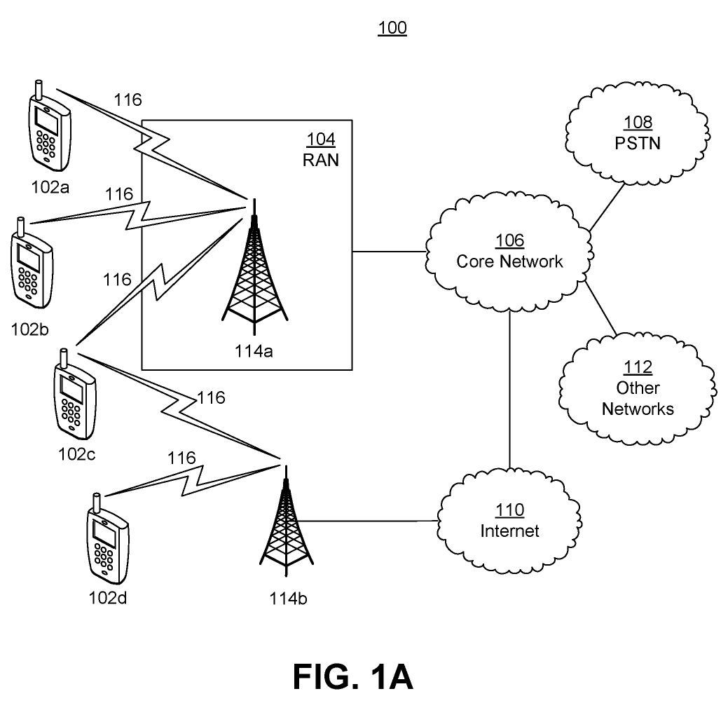

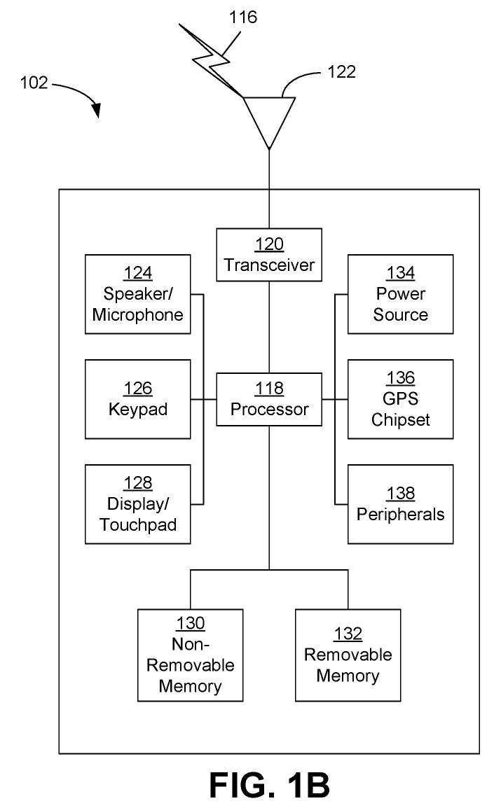

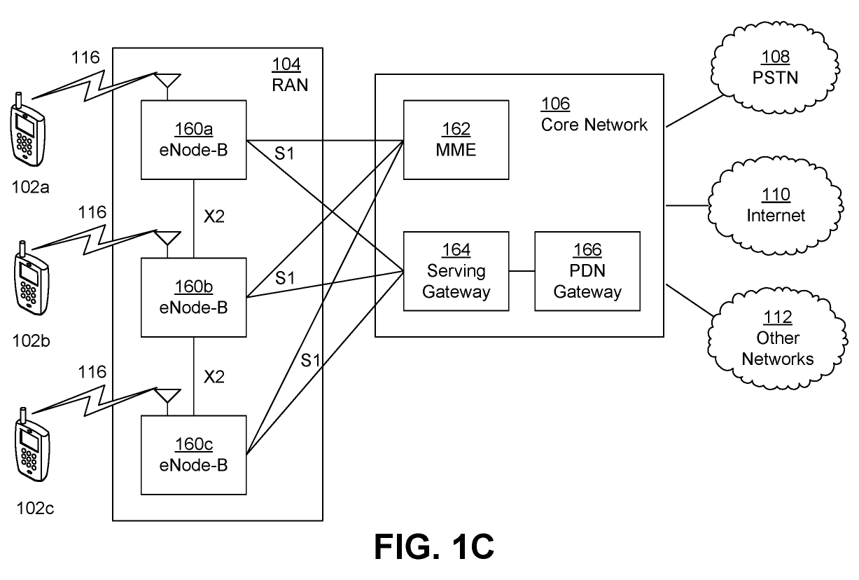

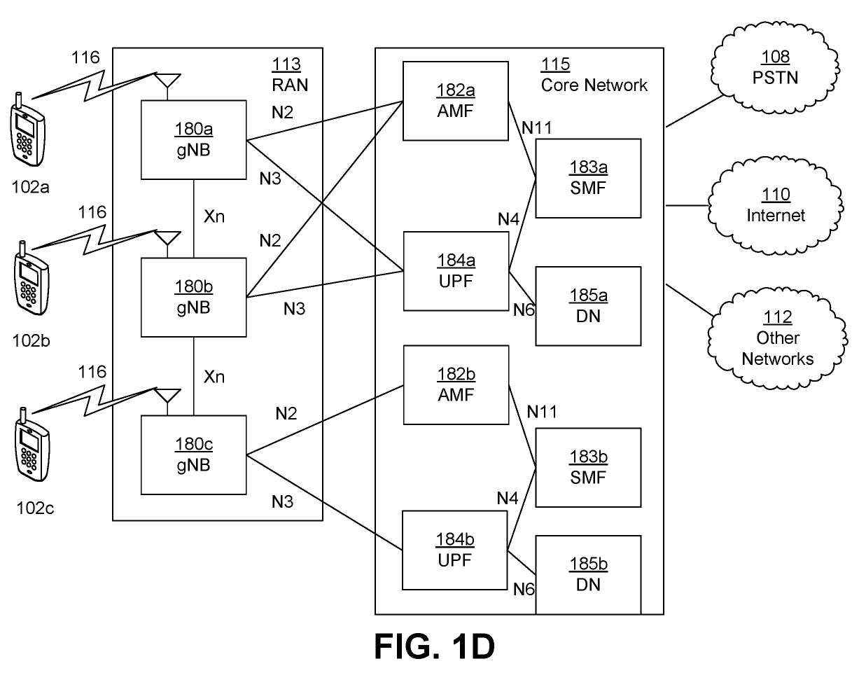

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access , which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU may receive configuration information, for example from a network (e.g., base station). The configuration information may include an indication of a first search space set and/or a second search space set. The first search space set may indicate first PDCCH candidates. The second search space set may indicate second PDCCH candidates. The WTRU may monitor at least one of the first PDCCH candidates indicated by the first search space set. The WTRU may receive an indication (e.g., from the network) that the second search space set is linked to the first search space set. The WTRU may monitor at least one of the second PDCCH candidates indicated by the second search space set, for example based on the indication that the second search space set is linked to the first search space set. The WTRU may receive DCI, for example via one or more of the at least one of the first PDCCH candidates or the at least one of the second PDCCH candidates. The WTRU may receive the indication that the second search space set is linked to the first search space set in one or more of a DCI or a medium access control (MAC) transmission.

The indication that the second search space set is linked to the first search space set may include an indication of a subset of the second PDCCH candidates. The WTRU may monitor the subset of the second PDCCH candidates. The indication that the second search space set is linked to the first search space set may include an indication of a start time and/or a time duration. The WTRU may monitor the at least one of the second PDCCH candidates indicated by the second search space set at the start time and/or for the time duration. The WTRU may stop monitoring the at least one of the second PDCCH candidates indicated by the second search space set after the time duration. The WTRU may monitor (e.g., repeat monitoring) the at least one of the first PDCCH candidates indicated by the first search space set, for example after the time duration.

The indication that the second search space set is linked to the first search space set may include an identifier (ID) of the second search space set. The WTRU may determine that the second search space set is linked to the first search space set based on the identifier of the second search space set. The first search space set may be linked to the second search space set and to a third search space set. The third search space set may indicate third PDCCH candidates. The second PDCCH candidates may include a first subset of repeated first PDCCH candidates and/or the third PDCCH candidates may include a second subset of repeated PDCCH candidates. The configuration information may include an indication of the third search space set. The indication that the second search space set is linked to the first search space set may include an indication that the third search space set is linked to the first search space set. The WTRU may be preconfigured with a configuration indicating that the first search space set is linked to a third search space set. The indication that the second search space set is linked to the first search space set may include an indication to change the configuration to link the first search space set with the second search space set.

NR may support search space sets linkage, for example to increase reliability of downlink control signaling. A WTRU may be configured with two semi-statically linked search space sets, for example that have the same parameters. The WTRU may (e.g., then) monitor the same PDCCH candidates in the linked search space set for possible repetitions. A WTRU may be configured to combine different repetitions of PDCCH on linked search space. A WTRU, that is for example configured to combine different repetitions of PDCCH on linked search space, may support more blind decoding efforts. A WTRU, for example not configured to combine different repetitions of PDCCH on linked search space, may monitor the PDCCH candidates in the linked search space set without combining repetitions and/or stop when decoding one of the PDCCH repetitions. Although decoding (e.g., one of) the PDCCH repetitions may enhance DCI reliability, combining multiple PDCCH repetitions may be desirable for example to enhance performance.

Systems and methods herein may include PDCCH repetition, for example PDCCH candidate repetition. The network may adjust search space set parameters, for example to use PDCCH repetition or not. The network may determine to adjust the search space set parameters for example based on conditions at the WTRU (e.g., poor coverage scenario). If conditions at the WTRU are dynamically changing for example, semi-static adaptation may not be used. Additionally, or alternatively, a WTRU may not be configured to monitor a high number of PDCCH candidates, for example for an extended period of time.

Systems and methods herein may enable dynamic adaptation of downlink control parameters. The WTRU may determine a linked search space set to a search space set, for example based on a dynamic indication from the network (e.g., DCI and/or MAC). The WTRU may monitor a (e.g., additional) linked search space set for PDCCH repetition, for example when the WTRU receives a DCI indicating the additional linked search space set and/or the corresponding number of PDCCH candidates.

A WTRU may be configured with a first search space set, for example with a first number of PDCCH candidates. The WTRU may be configured with additional search space set(s), for example that may be dynamically linked to the first search space set. Linked search space sets may be used for PDCCH repetition(s). The WTRU may monitor the first search space set, for example for a first occurrence. Additionally, or alternatively, the WTRU may monitor the first search space set using the first number of PDCCH candidates.

The WTRU may receive an indication in the first search space set. The indication may indicate that additional search space sets are linked to the first search space set (e.g., indication transmitted in a DCI). Additionally, or alternatively, the indication may indicate additional search space set(s) IDs = to the first search space set, a subset (e.g., fraction) of the first number of PDCCH candidates to monitor in the additional search space set(s), a start time (e.g., Tₛₜₐᵣₜ) , and/or a time duration (e.g., D). The subset of the first number of PDCCH candidates to monitor in the additional search space set(s) may include half of the first number of PDCCH candidates to be monitored in the additional search space set for example. The start time (e.g., Tₛₜₐᵣₜ) may include an indication of when the WTRU should start monitoring the additional search space set(s). The time duration (e.g., D) may include an indication of how long the WTRU should monitor the additional search space set(s).

The WTRU may start monitoring the subset (e.g., fraction) of the first number of PDCCH candidates in the indicated additional search space set(s), for example from Tₛₜₐᵣₜ to Tₛₜₐᵣₜ +D. The WTRU may monitor the remaining PDCCH candidates in the first search space set, for example from Tₛₜₐᵣₜ to Tₛₜₐᵣₜ +D. The remaining PDCCH candidates may include the first number of PDCCH candidates minus the subset (e.g., fraction) of the first number of PDCCH candidates. The WTRU may receive a DCI, for example using a PDCCH candidate in the first search space set and/or a PDCCH candidate repetition in a linked additional search space set. The WTRU may (e.g., then) stop monitoring the additional search space sets at Tₛₜₐᵣₜ+D. The WTRU may monitor the first search space set, for example using the first number of PDCCH candidates starting from Tₛₜₐᵣₜ+D.

The network may send an indication to the WTRU, for example indicating that the WTRU should monitor additional search space set(s) for PDCCH repetition. For example the network may send the indication to the WTRU when the WTRU channel conditions are poor. The network may enable additional search space set monitoring, for example without increasing the WTRU blind decoding efforts.

Configuration as herein may correspond to one or more indications of one or more parameters (e.g., or similar) that a WTRU may receive. Configuration as herein may include configuration information, for example from a network (e.g., base station). The one or more parameters may configure one or more WTRU functions, WTRU methods, and/or WTRU procedures, etc. The WTRU being configured with a parameter may correspond to the WTRU receiving a configuration, for example comprising an indication of a value of the parameter.

Configuration may correspond to an initial configuration and/or to a reconfiguration. A reconfiguration may change, add, and/or remove, etc., parameters, for example of a previously received configuration. A configuration may be received with radio resource control (RRC) signaling for example (e.g., in one or more RRC message(s), and/or over RRCSetup, RRCResume, RRCReconfiguration, RRCReestablishment, and/or any other RRC message(s)).

A configuration may be received with medium access control (MAC) signaling for example (e.g., in one or more MAC message(s)). For example, MAC signaling may apply ASN.1 encoding, may include one or more MAC control messages, and/or may be in the form of one or more MAC control elements (CEs). A MAC signaling message and/or MAC control message may be distinct from the one or more MAC CEs.

The WTRU may receive configuration information/a configuration in one or more messages. A message carrying a configuration may include RRC signaling and/or MAC signaling for example. The WTRU may receive a configuration, for example from a network. A configuration may include portions of the configuration (e.g., configuration information). For example a first portion of a WTRU configuration parameters may be received with RRC signaling and/or a second portion of the WTRU configuration parameters may be received with MAC signaling. For example, the first portion may include parameters related to functionality common to one or more distributed units (DUs) associated with a central unit (CU), for example where DU and/or CU may be network entities. The CU may indicate to the first portion to the WTRU (e.g., using RRC signaling).

The second portion may include parameters related to functionality, for example that may be controlled by the DU. The WTRU may receive the second portion from one or more DU(s) (e.g., using MAC signaling). Additionally, or alternatively, a WTRU may receive configuration information from both CU and DU, for example with RRC signaling. Additionally, or alternatively, a WTRU may receive configuration information from both CU and DU, for example with MAC signaling.

The WTRU may be configured with one or more control resource set (CORESET). A CORESET may include frequency and/or time resources, for example a set of resource blocks (RBs) and/or a set of symbols and/or slots. The WTRU may be configured with a CORESET, for example with a contiguous set of RBs. Additionally, or alternatively, the WTRU may be configured with a CORESET, for example with a non-contiguous set of RBs. The WTRU may be configured with a CORESET, for example with a contiguous set of symbols and/or slots. Additionally, or alternatively, the WTRU may be configured with a CORESET, for example with a non-contiguous set of slots/RBs. A CORESET may be configured within a single carrier (e.g., the frequency resources of the CORESET may be within a single carrier). A CORESET may be configured within multiple carriers (e.g., the frequency resources of the CORESET may be within a multiple carriers).

The WTRU may receive an indication, for example from the network. The indication may indicate that the WTRU should start monitoring one or more CORESET in one or more carriers. The indication may be a dynamic indication, for example using lower layer signalling (e.g., physical channel/signal).

The WTRU may be configured with a PDCCH indication, for example that indicates that the WTRU should start monitoring one or more CORESET(s) from a pre-configured list of CORESET(s). The PDCCH indication may be transmitted in a pre-configured fixed location. The WTRU may start monitoring (e.g., all) the search space sets associated with the indicated CORESET, for example upon receiving an indication to monitor a CORESET.

The WTRU may receive an indication (e.g., including the indication to monitor a CORESET), for example including which search space set(s) from the associated with the CORESET to monitor. For example a CORESET may be associated with four search space sets. The WTRU may receive a PDCCH indication, for example indicating that the WTRU start monitoring the CORESET and a subset of search space sets (e.g., only 2 search space sets from the 4 search space sets). The WTRU may receive a MAC CE, for example that indicates to the WTRU to monitor a control resource set. The indication may indicate (e.g., to the WTRU) the search space sets to monitor within the CORESET.

The WTRU may be configured to determine the associated CORESET, for example with a search space set using dynamic indication (e.g., physical downlink transmission and/or MAC CE). A search space set may be configured, for example (e.g., initially) without an association with CORESET. Additionally, or alternatively, the WTRU may determine the associated CORESET using dynamic signalling (e.g., DCI and/or a physical downlink control channel/signal). Additionally, or alternatively, the WTRU may be configured (e.g., initially) with an association between a search space set and CORESET, and/or the WTRU may receive an indication that changes the association (e.g., a DCI indicates to the WTRU another CORESET to be associated with the search space set).

The WTRU may be configured with one or more search space sets. A search space set may be configured with one or more CORESET(s). The WTRU may monitor the search space set in the multiple CORESETs (e.g., the same search space set may be applied to different CORESET), for example when the WTRU is configured with a search space set that is associated with multiple CORESETs. For example the WTRU may be configured with two CORESET(s), with a first CORESET configured in a first set of RBs and the second CORESET configured in a second set of RBs. The WTRU may be configured with a search space set with a monitoring periodicity of p1 and/or a number of PDCCH candidates N1. Additionally, or alternatively, the WTRU may be configured with a search space set associated with first and second CORESETs. The WTRU may monitor the search space set in the first and/or second set of RBs with periodicity of p1 and/or number of candidates N1 in each CORESET.

The WTRU may be configured with a-periodic search space sets. The WTRU may be configured with search space set parameters, for example where one of the parameters may indicate the search space set type (e.g., whether the search space set is a-periodic search space set). The WTRU may start monitoring the a-periodic search space set, for example after receiving an indication from the network. The WTRU may (e.g., then) monitor the a-periodic search space set for a pre-configured duration (e.g., a number of slots). Additionally, or alternatively, the network indication may indicate (e.g., to the WTRU) the duration (e.g., time duration) to monitor a-periodic search space set. The WTRU may start monitoring the a-periodic search space set, for example after receiving a PDCCH indication to monitor a CORESET associated with the search space set.

The WTRU may receive a MAC CE, for example including an indication that indicates (e.g., to the WTRU) to start monitoring a-periodic search space set. The MAC CE may indicate (e.g., to the WTRU) to start monitoring one or more a-periodic search space set(s).

The WTRU may be configured to monitor a semi-persistent and/or aperiodic search space set, for example after the WTRU transmits an uplink signal/channel to the network. For example the WTRU may be configured with the a-periodic search space set and/or (e.g., initially) may not monitor the search space set. The WTRU may (e.g., then) be triggered to transmit an uplink transmission to the network. After the uplink transmission for example, the WTRU may start monitoring the a-periodic search space for a pre-configured period of time (e.g., the a-periodic search space configuration may indicate to the WTRU the duration (e.g., time duration) to monitor the search space set after initially starting to monitor the search space set). Additionally, or alternatively, the WTRU may be configured to receive an indication to stop monitoring the a-periodic search space set.

The WTRU may monitor a semi-persistent and/or aperiodic search space set, for example after the WTRU sends a transmission to the network. The transmission may include a BSR, a physical random access channel (PRACH) transmission, a scheduling request (SR), a physical uplink control channel (PUCCH) transmission, and/or an uplink transmission with a specific configuration.

The transmission may include a BSR. For example, the WTRU may be configured with a logical channel group, for example such that upon transmitting BSR for those logical channel(s) (LCH) and/or logical channel group(s) (LCG), the WTRU may start monitoring the a-periodic search space set. The WTRU may be pre-configured with a list of LCH/LCG, for example that may trigger the monitoring of the a-periodic search space set.

The transmission may include a PRACH transmission. The WTRU may be configured with a PRACH preamble partition that, for example upon transmitting one of the PRACH resources, may trigger the WTRU to monitor the a-periodic search space set. The transmission may include a SR. The WTRU may be configured with a SR configuration, for example such that that transmitting one of the SR resources triggers the WTRU to monitor the a-periodic search space set. The transmission may include a PUCCH transmission. The WTRU may be configured with a PUCCH configuration, for example such transmitting one of the PUCCH resources triggers the WTRU to monitor the a-periodic search space set. The transmission may include an uplink transmission with specific configuration (e.g., with specific beam configuration). For example, an uplink transmission configuration may be pre-configured to trigger the WTRU to monitor a-periodic search space set.

The WTRU may be configured with one or more semi-persistent search space sets. The WTRU may be configured with search space set parameters, for example where one of the parameters may indicate the search space set type (e.g., whether the search space set is semi-persistent search space set). The WTRU may start monitoring a semi-persistent search space set, for example after receiving an indication from the network. The WTRU may start monitoring semi-persistent search space set, for example after receiving a PDCCH indication to monitor a CORESET associated with the search space set. The WTRU may stop monitoring semi-persistent search space set, for example after receiving an indication from the network. For example a PDCCH indication may indicate that the WTRU should stop monitoring a semi-persistent search space set.

The WTRU may receive a MAC CE, for example that indicates that the WTRU should start monitoring semi-persistent search space set. The MAC CE may indicate that the WTRU should start monitoring one or more semi-persistent search space set(s). The WTRU may receive a MAC CE, for example that indicates that the WTRU should stop monitoring a semi-persistent search space set. The MAC CE may indicate that the WTRU should stop monitoring one or more semi-persistent search space set(s).

The WTRU may be configured with a fallback search space set, for example that may be monitored by the WTRU. For example the fallback search space set may be monitored by the WTRU when there is no scheduling activity and/or DCI received in (e.g., any of) the configured search space set(s) (e.g., when there is no DCI received in any linked search space set). For example the WTRU may be configured to monitor a linked search space set, and the WTRU may not receive (e.g., any) DCI for a pre-configured duration. The WTRU may (e.g., then) switch to monitor the fallback DCI.

The WTRU may be configured to monitor a first search space set continuously and/or to monitor an a-periodic search space set and/or semi-persistent search space set when (e.g., the WTRU is) triggered to monitor. The WTRU may be configured to monitor linked search space sets.

The WTRU may be configured with a first search space set, for example where the first search space set may be linked to one or more additional search space sets. The WTRU may be configured with one or more parameters for the first search space set. The one or more parameters may include a PDCCH monitoring periodicity, a PDCCH monitoring pattern within a slot, a duration of the first search space set, a bitmap indicating the slots to monitor within a group of slots, a number of PDCCH candidates, DCI format(s) to monitor within the first search space set, a bitmap indicating a frequency location to monitor the first search space set, associated CORESET(s), linked search space set(s), and/or linkage ID.

The duration (e.g., time duration) of the first search space set may include the number of slots and/or symbols to monitor the first search space set. The number of PDCCH candidates may be the first number of PDCCH candidates. For example, for each aggregation level, the WTRU may be configured with a number of PDCCH candidates to monitor in the first search space set. The DCI formats to monitor within the first search space set may include one or more DCI formats configured for the WTRU to monitor in the first search space set. The WTRU may be configured to associate the first search space set with one or more CORESET(s). The WTRU be configured with a list of search space sets (additional search space sets). The WTRU may be configured to always monitor the linked search space sets. Additionally, or alternatively, the WTRU may be configured to monitor the linked search space based on one or more configured triggers (e.g., the WTRU only monitors the linked search space sets when it is triggered). The WTRU may be configured with a parameter that indicates to the WTRU linkage identifier for one or more linked search space sets.

One or more additional search space set(s) may be configured to the WTRU. The additional search spaces may be linked to the first search space set, for example a subset of the additional search space sets configured to the WTRU may be linked to the first search space set. The WTRU may be configured with linked search space sets to receive DCI and/or PDCCH repetitions (e.g., the same DCI may be transmitted in each of the PDCCH repetitions). For example, the WTRU may be configured with a first search space set linked to a second search space set. The WTRU may monitor and/or receive PDCCH and a PDCCH repetition, for example where a first PDCCH transmission is transmitted in the first search space set and the repetition is transmitted in the second search space set. The PDCCH transmission and its repetition may be transmitted using the same coded bits, for example the same redundancy version. Additionally, or alternatively, PDCCH repetition(s) may be transmitted using different redundancy versions. The WTRU may receive a configuration, for example indicating the redundancy version of PDCCH transmission in (e.g., each of) the linked search space set(s).

The WTRU may be configured with linked search space sets, for example to increase the aggregation level. The WTRU may receive a PDCCH across linked search space sets. For example the WTRU may be configured with a first search space set that has a first number of control channel element (CCE)/resource element group (REG), linked with a second search space set that has a second number of CCEs/REG. The WTRU may be configured to monitor PDCCH candidate(s) that have CCE(s)/REG on the first search space set and/or other CCE(s)/REG on the second search space set, which for example may enable the WTRU to monitor high aggregation level of CCEs by monitoring two linked search space sets. The WTRU may receive a configuration indicating the aggregation level across the linked search space sets.

The WTRU may be configured with linked search space sets to receive a first and/or second stage DCI. The WTRU may be configured with a first search space set linked to a second search space set, for example where a first stage DCI may transmitted in the first search space set and/or the second stage DCI may be transmitted in the second search space set.

The WTRU may receive a configuration from the network, for example which indicates to the WTRU that one or more search space sets are linked (e.g., linked search space sets). The WTRU may be configured with the same search space set parameters for both search space sets, for example when the WTRU is configured with linked search space sets. For example the WTRU may be configured with a first search space set that is linked with a second search space set. The WTRU may be configured with the same parameters (e.g., all search space set parameters are the same) for both the first and second search space set.

The WTRU may be configured with some common parameters common and other different parameters, for example when the WTRU is configured with linked search space sets. For example the WTRU may be configured with a first search space set that is linked to a second search space set where at least one parameter is different. The WTRU may be configured with one or more of the parameters that are different for the first search space set and the linked search space set(s). The one or more parameters may include one or more of a number of PDCCH candidates, monitoring occasion(s), associated CORESET(s), DCI format(s), and/or first and/or second stage DCI.

The one or more parameters may include a number of PDCCH candidates. The WTRU be configured with two linked search space sets, for example that have a different number of PDCCH candidates. For example the WTRU may be configured with a first search space set that has N1 PDCCH candidates and a linked second search space set that has N2 PDCCH candidates. N1 may be less than N2.

The one or more parameters may include monitoring occasion(s). The WTRU may be configured with different monitoring occasions for the first search space set and the linked search space set(s). The WTRU may be configured with a monitoring offset to apply for linked search space sets. The WTRU may use the monitoring occasions configured for the first search space set to monitor PDCCH candidate on the first search space set and/or may apply the configured monitoring offset to the monitoring occasions of the first search space set to determine the monitoring occasions of the linked search space sets.

The one or more parameters may include associated CORESET(s). The WTRU may be configured with a first search space set associated with a first CORESET and/or a linked search space set associated with a second CORESET. The one or more parameters may include DCI format(s). The WTRU may be configured to monitor different DCI formats on a first search space set and the linked search space set(s), for example where at least one DCI format may be common among the first search space set and the linked search space sets. The one or more parameters may include first and/or second stage DCI. For example, the WTRU may be configured with a first search space set to receive first stage DCI and/or a second search space set linked to the first search space set to receive a second stage DCI.

The WTRU may be configured to determine whether two search space sets are linked search space sets. Two or more search space sets may be linked during a time period and unlinked (e.g., not linked) outside of that time period. The WTRU may be configured with one or more search space sets that could (e.g., potentially) be linked. For example in a search space set configuration, a parameter may indicate (e.g., to the WTRU) that a search space set may be potentially linked.

The WTRU may be configured to determine that two search space sets and/or multiple search space sets are linked, for example based on one or more of consecutive monitoring occasion for search space sets, a time window during which the search space sets are linked, and/or serving cell(s) corresponding to the search space sets. The WTRU may be configured to determine that two search sets and/or multiple search space sets are linked based on consecutive monitoring occasion for search space sets (e.g., inter-slot/inter-symbol). For example if a first search space set has a monitoring occasion in a slot and a second search space set has a monitoring occasion in the next slot, the WTRU may determine that the two search space sets are linked during the two slots. If a first search space set has a monitoring occasion in a first symbol(s) and a second search space set has a monitoring occasion in the next symbol for example, the WTRU may determine that the two search space sets are linked during those symbols.

The WTRU may be configured to determine that two search sets and/or multiple search space sets are linked based on a time window during which the search space sets are linked. For example, a WTRU may be configured with a time window during which two search space sets may be linked. The WTRU may be configured to determine that two search sets and/or multiple search space sets are linked based on serving cell(s) corresponding to the search space sets. The WTRU may be configured to link search space sets within different carriers, for example based on the carrier/cell associated with the search space set.

The WTRU may be configured with additional search space set(s), for example that may be linked to the first search space set. The WTRU may be semi-statically configured to link additional search space sets to the first search space set. The WTRU may (e.g., then) monitor the additional linked search space sets, for example continuously. The WTRU may be configured to (e.g., dynamically) link additional search space sets to the first search space set. For example the WTRU may monitor the additional linked search space sets when (e.g., dynamically) triggered to monitor the additional linked search space sets. The WTRU may be configured with the same search space set parameters for the additional search space sets that are linked, for example all of the additional search space sets that are linked. Additionally, or alternatively, the additional search space sets for linkage may be configured with different parameters, for example at least one different parameter).

The first search space set and/or the additional linked search space set may be a WTRU-specific search space (e.g., configured to the WTRU using WTRU-specific signaling) and/or a group common search space set (e.g., search space sets used for system information acquisition, initial access information, RACH procedures, and/or for group common signaling).

Systems and methods herein may monitor linked search space sets. There may be dynamic search space set linkage. The WTRU may be configured with a first search space set and additional search space sets that may be dynamically linked to the first search space set. The WTRU may be configured with a first number of PDCCH candidates, for example for the first search space set monitoring. The WTRU may start monitoring the first search space set, for example for a first occurrence, using the first number of PDCCH candidates. The WTRU may receive an indication in the first search space set, for example indicating that additional search space sets are linked to the first search space set. The WTRU may be configured to receive information in the dynamic search space set linkage indication. The information may include one or more of additional search space set(s) IDs linked to the first search space set, a subset (e.g., fraction) of the first number of PDCCH candidates to monitor in the additional search space set(s), a start time (e.g., Tₛₜₐᵣₜ), and/or a duration (e.g., D).

The information may include additional search space set(s) IDs linked to the first search space set. For example, the WTRU may receive a list of ID(s) indicating the search space set(s) that are dynamically linked from the pre-configured additional search space set(s). The information may include a subset (e.g., fraction) of the first number of PDCCH candidates to monitor in the additional search space set(s). The WTRU may be configured to receive an indication to monitor subset (e.g., fraction) of the first number of PDCCH candidates configured for the first search space set in the additional search space sets. For example, half of the first number of PDCCH candidates to be monitored by the WTRU may be indicated in the additional search space set. The information may include a start time (e.g., Tₛₜₐᵣₜ) and/or time duration (e.g., D), for example for where the WTRU should start monitoring the additional linked search space set. The WTRU may be configured with a start time for when to monitor the additional search space sets and/or the duration (e.g., time duration) for monitoring the additional search space sets.

The WTRU may receive the indication that additional search space sets are linked to the first search space set, for example using one or more of DCI in the first search space set, DCI in another search space set, and/or MAC CE. The WTRU may receive the indication that additional search space sets are linked to the first search space set using DCI in the first search space set. The WTRU may be configured with a bitfield in the DCI for example, to carry search space set linkage information. The DCI may be used with or without scheduling grants. The WTRU may receive the indication that additional search space sets are linked to the first search space set using DCI in another search space set. The WTRU may receive a DCI in a different search space set, for example carrying search space set linkage information with first search space set and/or additional search space sets.

The WTRU may receive the indication that additional search space sets are linked to the first search space set using MAC CE. The MAC CE may carry (e.g., all) the information related to the indication of linking additional search space sets. Additionally, or alternatively, the WTRU may receive part of the information in a DCI and part of the information in a MAC CE. For example, the WTRU may receive in the start time and duration (e.g., time duration) when to monitor additional linked search space sets in a DCI and/or a subset (e.g., fraction) of PDCCH candidates and the search space set IDs to be linked to the first search space set in a (e.g., subsequent MAC CE). For example the MAC CE may be in a PDSCH scheduled by the DCI that indicated the start time and duration (e.g., time duration) to the WTRU.

The WTRU may monitor dynamically linked search space set(s). For example the WTRU may not monitor the additional search space set until the WTRU receives the dynamic search space set linkage. Additionally, or alternatively, the WTRU may be configured to monitor the additional search space set(s), for example without assuming the linkage. For example the additional search space set may not be used initially for PDCCH repetition/two-stage DCI/aggregation of resource to transmit one PDCCH. The WTRU may start monitoring the additional search space sets, for example upon receiving the indication that the additional search space sets are linked. Additionally, or alternatively, the WTRU may start monitoring the additional search space sets if the additional search space sets are linked with the first search space set and/or use the indicated information (e.g., subset/fraction of the first number of PDCCH candidates).

The WTRU may start monitoring a subset (e.g., fraction) of the first number of PDCCH candidates, for example initially configured for the first search space set, in the indicated additional search space set(s) starting from the indicated start time Tₛₜₐᵣₜ to Tₛₜₐᵣₜ +D. D may be the indicated duration (e.g., time duration) to monitor the additional linked search space set(s). The WTRU may be configured to stop monitoring the additional search space sets at Tₛₜₐᵣₜ+D.

The WTRU may determine PDCCH candidates in linked search space sets. The WTRU may be configured to distribute the subset (e.g., fraction) of the first number of PDCCH candidates over the additional linked search space sets and/or to monitor the remaining PDCCH candidates in the first search space set. The remaining PDCCH candidates may be (e.g., equal to) the first number of PDCCH candidates minus the subset (e.g., fraction) of the first number of PDCCH candidates.

For example the WTRU may be configured to monitor three additional search space sets linked to the first search space set. The WTRU may be configured to monitor with a first number of PDCCH candidates equal to N and/or may receive a dynamic search space set linkage indicating that the subset (e.g., fraction) of the first number of PDCCH candidates is equal to 1/2. The WTRU may monitors (N/2)/3 PDCCH candidates in each of the additional linked search space sets and monitors N/2 PDCCH candidates in the first search space set. The WTRU may be configured to monitor the first search space set using the first number of PDCCH candidates, for example after the end of the search space set linkage (e.g., starting from Tₛₜₐᵣₜ+D).

The WTRU may be configured to distribute the first number of PDCCH candidates over the additional linked search space sets and/or the first search space set. For example the WTRU may be configured to monitor three additional search space sets linked to the first search space set (e.g., total search space sets linked may be equal to 4). The WTRU may be configured to monitor with a first number of PDCCH candidates equal to N. After receiving dynamic search space set linkage for example, the WTRU may monitor N/4 PDCCH candidates in (e.g., each of) the linked search space sets (e.g.., N/4 PDCCH candidates in the first search space set and N/4 PDCCH candidates for each of the additional linked search space sets). The WTRU may be configured to monitor the first search space set using the first number of PDCCH candidates, for example after the end of the search space set linkage (e.g., starting from Tₛₜₐᵣₜ+D).

The WTRU may decode PDCCH candidates in linked search space set(s). The WTRU may be configured to receive a DCI, for example using at least one of a PDCCH candidate in the first search space set and/or a PDCCH candidate repetition in a linked search space set. The WTRU may be configured with the same number of PDCCH candidates to monitor in the first search space set and/or in each of the additional linked search space set. For example the WTRU may expect the same coded bits of the DCI in each linked search space set. For example each PDCCH transmission may carry to the WTRU the same coded bits (e.g., the same redundancy version). The WTRU may be configured to decode one of the PDCCH repetition and/or the WTRU may be configured to combine the different PDCCH repetitions. For example, the WTRU may combine multiple PDCCH repetitions to decode the DCI. The WTRU may be configured to receive different coded bits of DCI (e.g., different redundancy version), for example in each PDCCH repetition.

The WTRU may be pre-configured with the redundancy version corresponding to each linked search space set where the PDCCH repetition will be transmitted. The WTRU may combine the different coded bits of the DCI received in PDCCH repetitions, for example each PDCCH repetition.

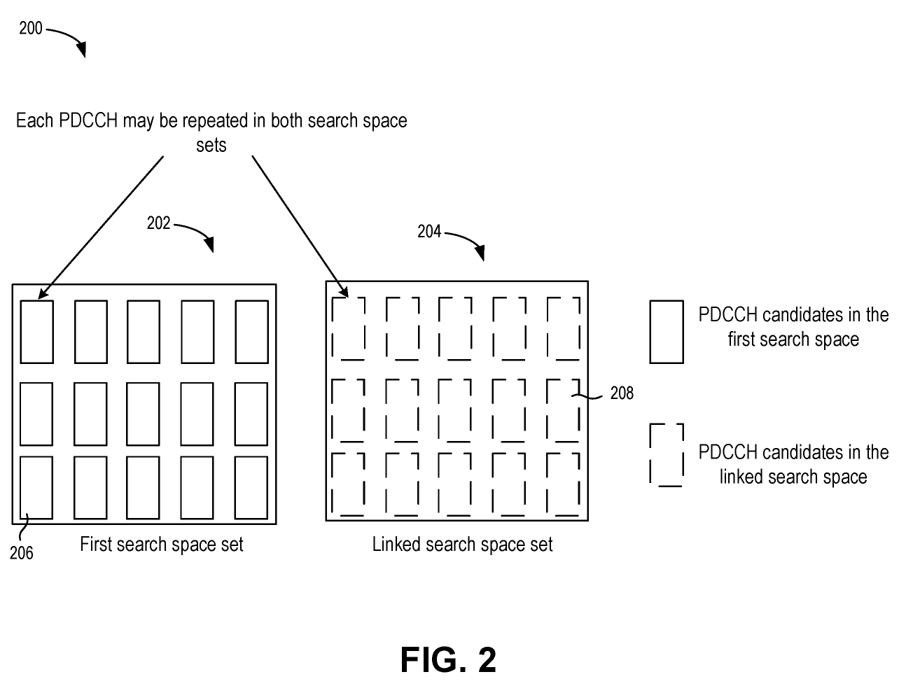

FIG. 2 is an example of linked search space sets 200 with the same number of PDCCH candidates. A first search space set 202 includes PDCCH candidates 206. A configuration may include an additional linked search space set 204. The linked search space set 204 may include PDCCH candidates 208. For example the linked search space set 204 may include the same number of PDCCH candidates 208 as the number of PDCCH candidates 206 in the first search space set 202. Each PDCCH candidate in the first search space set may have a corresponding candidate in the linked search space set.

A WTRU may be configured with different number PDCCH candidates in the first search space set and the additional linked search space set. The WTRU may be configured with higher number of PDCCH candidates in a linked search space set compared to the first search space set. For example, for each PDCCH candidate in the first search space set there may be a corresponding N PDCCH candidates in the linked search space set. The WTRU may (e.g., then) expect N+1 PDCCH transmission carrying the same DCI.

The WTRU may be configured with a smaller number of PDCCH candidates in a linked search space set compared to the first search space set. If for example the WTRU may be configured with a smaller number of PDCCH candidates in a linked search space set compared to the first search space set, not all PDCCH candidates of the first search space set may be repeated in the linked search space set. A first search space set may be configured with N PDCCH candidates with a linked search space set configured with N/2 PDCCH candidates and/or the WTRU may receive a PDCCH repetition of N/2 PDCCH (e.g., not the entire N PDCCH candidates). The WTRU may be configured with the possible PDCCH candidates that may be repeated in a linked search space set. For example, a bitmap with the size of number of PDCCH candidates may indicate to the WTRU whether a candidate may be repeated in a linked search space set or not. For example a 1 value may be used for PDCCH that can repeated and a 0 value may be used for PDCCH that will not be repeated. The WTRU may be configured with a list of possible PDCCH candidates to be repeated, for example for each linked search space set. The list may be different from one linked search space set to another.

The WTRU may be configured with a first search space set, for example with N PDCCH candidates to monitor. The WTRU may be configured with dynamic search space set linkage and/or may receive an indication to link two additional search space sets to the first search space set (e.g., second search space set and third search space set). The WTRU may receive an indication to monitor half of the PDCCH candidates in the additional linked search space set, for example N/2 PDCCH candidates in both second and third search space set and the remaining PDCCH candidates. The WTRU may (e.g., then) monitor N/2 PDCCH candidates in the first search space set, N/4 PDCCH candidates in the second search space set, and/or N/4 PDCCH candidates in the third search space set. The WTRU may be configured with which of the N/2 PDCCH candidates in the first search space set may be repeated in the second search space set and/or which of the N/2 PDCCH candidates may be repeated in the third search space set. For example, the WTRU may be configured to monitor the repetition of the first N/4 PDCCH candidates in the first search space set in the second search space set, and/or the remaining N/4 PDCCH candidates of the first search space set in the third search space set.

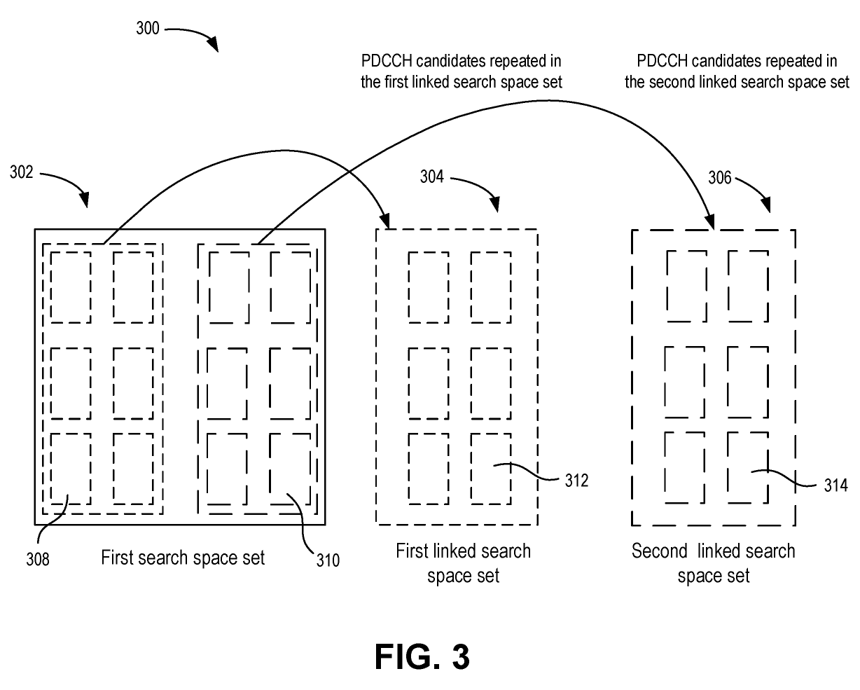

FIG. 3 is an example of linked search space sets 300 with a different number of PDCCH candidates. A first search space set 302 may include PDCCH candidates 308 and 310. The configuration may include two additional linked search space sets with different number of PDCCH candidates compared to the first search space set. For example a first linked search space set 304 may include PDCCH candidates 312 and/or a second linked search space set 306 may include PDCCH candidates 314. Half of the PDCCH candidates (e.g., PDCCH candidates 308) of the first search space set 302 may be repeated in the first linked search space set 304 (e.g., as PDCCH candidates 312) and/or the other half of PDCCH candidates (e.g., PDCCH candidates 310) may be repeated in the second linked search space set 306 (e.g., as PDCCH candidates 314).

A WTRU may adapt search space set parameters. The WTRU may be configured to adapt and/or dynamically change one or more search space set parameters. Search space set parameters may include one or more of where the search space set parameters may include one or more of a PDCCH monitoring periodicity, a PDCCH monitoring pattern within a slot, a duration (e.g., time duration) of the search space set, a bitmap indicating the slots to monitor within group of slots, a number of PDCCH candidates per aggregation level, a common or WTRU specific search space set, DCI format(s) to monitor within the search space set, a linkage to another search space set, a bitmap indicating frequency location to monitor, whether PDCCH repetition may be applied and the number of PDCCH repetition, a hashing function, and/or a search space set priority.

The search space set parameters may include multiple hashing function, for example where each hashing function may enable deactivation and/or puncturing of a subset of CCEs (e.g., when high CLI occurs of colliding with higher priority signal). The search space set parameters may include a search space set priority. For example, a search space set may be configured with a priority that the WTRU may use to determine which search space set to monitor in case of overbooking. For example the WTRU may select the higher priority search space sets. The WTRU may be configured to change and/or adapt the search space set priority. The WTRU may be configured to adapt a search space set and its linked search space set(s), for example where each linked search space set may have different changes to parameters.

There may be one or more triggers to adapt search space set parameters. The WTRU may be configured to adapt and/or change the search space set parameters and/or a (e.g., any) linked search space set parameters, and/or activate/deactivate a search space set, for example based on one or more of a network indication, measurement result(s), collision with high priority signals/channels, coverage condition change(s), an energy saving state for the WTRU, an energy saving state for the network, and/or change(s) to a number of carrier triggers. For example for multi-carrier (e.g., fragmented carriers operating as single carrier), a change of the number of carriers may trigger the WTRU to change the search space set parameters.

The WTRU may be configured to adapt and/or change the search space set parameters and/or a (e.g., any) linked search space set parameters, and/or activate/deactivate a search space set based on a network indication. The WTRU may receive a MAC CE, for example indicating that one or more search space set(s) should be activated/deactivated. The WTRU may receive (e.g., from the network) a DCI/MAC CE indicating that one or more search space set parameters should be changed. The WTRU may receive an indication in the DCI and/or MAC, for example indicating one or more changes in the search space set parameters.

The one or more changes may include a different PDCCH monitoring periodicity, a different PDCCH monitoring pattern within a slot, a different duration of the search space set, a different bitmap indicating the slots to monitor within group of slots, a different number of PDCCH candidates per aggregation level, a linking of the search space set to a new search space set, different DCI format(s) to monitor in the search space set, a different frequency location to monitor, and/or a different hashing function for the search space set. The WTRU may be configured with different value of the parameters and/or the DCI and/or MAC CE may indicate one of the configured values of using a bitfield (e.g., bitfield pointing to different codepoint).

The WTRU may be configured to adapt and/or change the search space set parameters and/or a (e.g., any) linked search space set parameters, and/or activate/deactivate a search space set based on measurement result(s). For example, the WTRU may be configured with a SSB/CSI-RS/SRS resource to measure and/or may adapt/change one or more search space set parameters based on the measurement results (e.g., below a configured threshold). A (e.g., each) search space set parameter may be associated with one or more measurement results.

The WTRU may determine the aggregation level of a DCI format to monitor in a search space set, for example based on the measurement result of SSB/CSI-RS/SRS being above or below a configured threshold. For example, the WTRU may be configured to monitor a DCI format in a search space set with aggregation levels AL=1, 2, 4 and 8. If the RSRP measurement of SSB/CSI-RS/SRS is above a configured threshold for example, the WTRU may monitor the DCI format with aggregation levels AL=8 and 16. The WTRU may be configured to monitor a DCI format in a search space set with aggregation levels AL= 8 and 16. If the RSRP measurement of SSB/CSI-RS/SRS is below a configured threshold for example, the WTRU may monitor the DCI format with aggregation levels AL=1, 2, 4 and 8. The WTRU may adapt/change the search space set parameters, for example based on a cross link interference (CLI) level. The WTRU may be configured to report to the network (e.g., gNB) the CLI level and/or (e.g., then) adjust the monitoring parameter(s) of the search space set.

The WTRU may be configured to adapt and/or change the search space set parameters and/or a (e.g., any) linked search space set parameters, and/or activate/deactivate a search space set based on collision with high priority signals/channels. For example, the WTRU may determine that high priority signals/channels are transmitted in the same occasions of monitoring occasions of a search space set. The WTRU may receive the indication from the gNB indicating high priority channel/signal transmissions. The WTRU may be configured to apply a different PDCCH monitoring periodicity and/or PDCCH monitoring pattern within a slot, a duration of the search space set, and/or the slots to monitor within group of slots, for example when detecting the presence of priority signals/channels. The WTRU may be configured to not monitor the search space set, for example in the frequency resources corresponding to the resources of the high priority signals/channels (e.g., when detecting the presence of priority signals/channels). The WTRU may apply a different hashing function and/or bitmap indicating frequency location to monitor to exclude the frequency resources corresponding to the resources of the high priority signals/channels. High priority signals/channels may be a different RAT signal/channel, for example such as 5G SSB/PDCCH/CORESET/SIB/paging.

The WTRU may be configured to adapt and/or change the search space set parameters and/or a (e.g., any) linked search space set parameters, and/or activate/deactivate a search space set based on coverage conditions changes. For example, the WTRU may have a different coverage level. The WTRU may determine the search space set parameters based on coverage level. The WTRU may determine the coverage level based on measurements (e.g., RSRP), for example of DL reference signals (e.g., SSB/CSI-RS. The WTRU may be configured to use monitor different number of PDCCH repetitions for a (e.g., each) coverage level. Coverage level may be associated with different RSRP ranges of the measurement of DL reference signals.

The WTRU may be configured to adapt and/or change the search space set parameters and/or a (e.g., any) linked search space set parameters, and/or activate/deactivate a search space set based on energy saving state for WTRU. The WTRU may be configured to apply a different PDCCH monitoring periodicity and/or PDCCH monitoring pattern within a slot/duration of the search space set/the slots to monitor within group of slots, for example when the WTRU is in power saving mode.

The WTRU may be configured to adapt and/or change the search space set parameters and/or a (e.g., any) linked search space set parameters, and/or activate/deactivate a search space set based on energy saving state for the network. The WTRU may be configured to apply different PDCCH monitoring periodicity and/or PDCCH monitoring pattern within a slot/duration of the search space set and/or the slots to monitor within group of slots when the WTRU receives an indication from the network indicating energy saving mode for the serving cell. The WTRU may be configured to monitor a reduced number of CCE(s), for example when the network indicates a cell energy saving mode. For example, the WTRU may be configured to monitor a search space set with a first number of CCEs. When the WTRU receives an indication that the cell is in energy saving mode for example, the WTRU may monitor the search space set with smaller number of CCEs.

The WTRU may be configured with a search space set that may be associated with two CORESETs. The WTRU may be configured to change an associated CORESET associated with a search space set. The WTRU may receive an indication from the network. The indication may indicate that the WTRU should change the association between the search space and the CORESET.

The WTRU may be configured to determine the CORESET associated with the search space set based on a sub-band full duplex (SBFD) configuration (e.g., SBFD frequency configuration and/or time configuration). For example, the WTRU may be configured with SBFD, where some of the frequency resources of the BWP/carrier are allocated for uplink transmission and/or other frequency resource of the BWP/carrier are allocated for downlink transmission. The WTRU may be configured with a search space set that is associated with a first CORESET (e.g., wideband CORESET) in non-SBFD symbols and/or a second CORESET (e.g., narrowband CORESET) in SBFD symbols. During non-SBFD symbols for example, the WTRU may associate the search space set with the first CORESET and/or during SBFD symbols, the WTRU may associate the search space set with the second CORESET.

The WTRU may be configured with multiple search space sets, for example where each search space set is associated with a coverage level. The configuration may be received in broadcast system information (e.g., SIB/MIB/PBCH/SSB) for example. A search space set may be associated with a coverage level and/or may have a different number of PDCCH repetitions. For example, the WTRU may be configured with a first search space set associated with a first coverage level and/or may be configured without PDCCH repetitions. The WTRU may be configured with a second search space set associated with a second coverage level and/or may be configured one PDCCH repetition. The WTRU may be configured with a third search space set associated with a third coverage level and/or may be configured with two PDCCH repetitions.

The PDCCH repetition(s) may be transmitted in a linked search space set or in the same search space set for example. The WTRU may be configured to (e.g., first) determine coverage level. Based on the WTRU’s coverage level for example, the WTRU may determine the search space set to monitor. The coverage level may be associated with different RSRP ranges of the measurement of DL reference signals. The WTRU may determine the coverage level based on measurements (e.g., RSRP) of DL reference signals, for example SSB and/or CSI-RS.

The WTRU may detect SSB of a cell, for example during an initial access procedure. The WTRU may determine that the cell supports four coverage levels, for example where each coverage level is associated with a SSB-RSRP range. For example RSRP1 to RSRP2 may define coverage level 1, RSRP2 to RSRP3 may define coverage level 2, RSRP3 to RSRP4 may define coverage level 3, and/or RSRP4 to RSRP5 may define coverage level 4. The WTRU may receive the association between different coverage levels and the search space sets, for example using MIB/PBCH signaling. The WTRU may measure the RSRP of SSB. The WTRU may determine the coverage level, for example based on the measurement results. The WTRU may (e.g., then) monitor the search space set(s) associated with the determined coverage level.

The WTRU may be configured with multiple PRACH preamble partitions/sets. A (e.g., each) set/partition may be associated with different search space sets. A PRACH preamble partition/set may be associated with multiple search space sets. Depending on the selected PRACH preamble for example, the WTRU may determine the search space set according to the association between a search space set and a PRACH preamble partition. The WTRU may use the determined search space set to monitor the DCI transmission, for example carrying scheduling for random access response (RAR).

Systems and methods may include PDCCH overbooking. The WTRU may be configured to monitor a number of PDCCH candidates, for example that is larger than the WTRU’s blind decoding capability. The WTRU may be configured to prioritize a sub-set of PDCCH candidates to monitor over other PDCCH candidates, for example when the WTRU is configured to monitor the number of PDCCH candidates that is larger than the WTRU blind decoding capability. For example, the WTRU may stop/prioritize monitoring a (e.g., entire) search space set over another search space set. The WTRU may be configured to prioritize monitoring a search space set with high priority. For example the WTRU may monitor the highest priority search space set(s) until the WTRU reaches its blind decoding capability.

The WTRU may be configured to prioritize monitoring search space set based on the carrier type, for example the carrier type scheduled by the search space set. For example, the WTRU may prioritize monitoring the search space set(s), scheduling MRSS carrier(s), scheduling SBFD carrier(s), and/or primary cell. The WTRU may be configured to prioritize monitoring search space set with a linked search space set(s). For example if the WTRU reaches maximum blind decoding capability, the WTRU may stop monitoring search space sets which do not have linked search space sets. The WTRU may prioritize monitoring search space sets that are linked to other search space sets.

The WTRU may be configured to prioritize monitoring a subset of PDCCH candidates within a search space set, for example when the WTRU blind decoding capability is reached. The WTRU may be configured to prioritize monitoring the first PDCCH candidates of a search space set, for example based on PDCCH numbering within the search space set, up to the number of PDCCH corresponding to the WTRU blind decoding capability. The WTRU may be configured to scale down the number of PDCCH candidates on a (e.g., each) search space set(s). For example the WTRU may multiply the configured PDCCH candidates of a search space set by a scaling factor. The WTRU may be configured to multiply the number of PDCCH candidates of each search space set by different scaling factor. The WTRU may be configured with a scaling factor corresponding to a (e.g., each) search space set, for example during the search space set configuration and/or indicated by the network (e.g., using MAC CE and/or DCI). The WTRU may be configured with the same scaling factor for all linked search space sets for example.

The WTRU may be configured with a first search space set, for example that is independent of any dynamic indication (e.g., permanent SS set). The WTRU may be configured with additional search space set(s), for example where the SS parameters may be dynamically adapted. Additionally, or alternatively, additional search space set(s) may be activated and/or deactivated. The dynamic adaptation of SS parameters may include one or more of monitoring occasion(s) (e.g., periodicity, the set of slots, and/or symbol within a slot), linked search space set(s) (e.g., a search space set may be linked to enable PDCCH repetitions), hashing function(s) (e.g., some CCEs may be excluded from search space set to allow other transmissions), and/or CORESET association(s) (e.g., a search space set may be re-associated with a larger CORESET in frequency and/or time).

The WTRU may be configured with default SS parameters for the additional search space set(s). The WTRU may determine the parameters for the additional search space set, for example based on one or more of a DCI indication received in the first search space set indicating which parameter to change, a DCI indication to activate/deactivate one or more search space set, channel measurement(s) (e.g., when SSB-RSRP is below a configured threshold the WTRU may indicate to the network and start monitoring two linked search space sets), a WTRU energy saving state, and/or a network energy saving state. The WTRU may monitor the additional search space set(s) with the indicated parameters. After a configured time period for example, the WTRU may monitor the additional search space set(s) with default parameters.

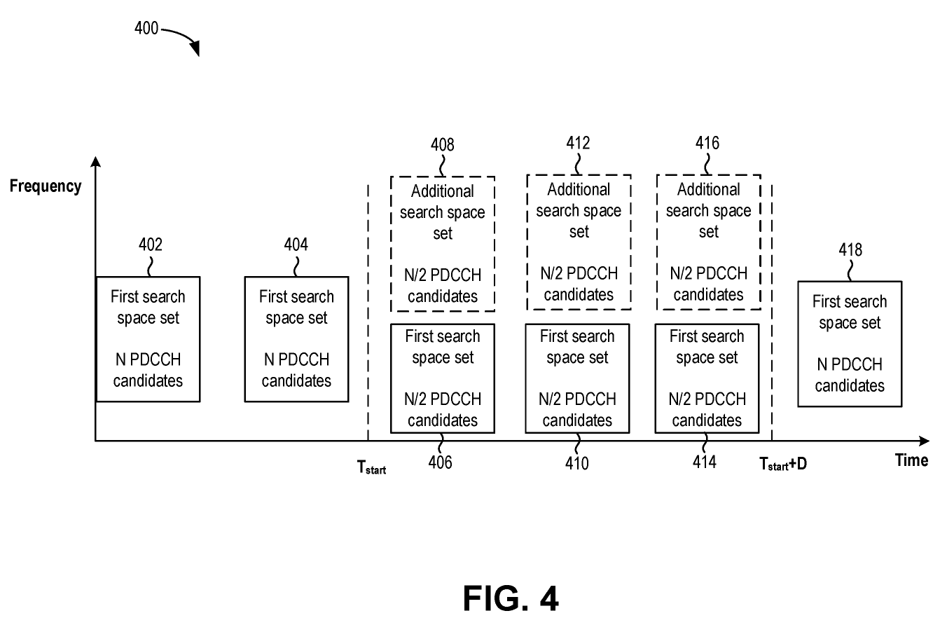

FIG. 4 is an example of WTRU monitoring of one or more search spaces 400. The WTRU may monitor a first search space set 402. The WTRU may continue to monitor the first search space set at a different time/slot, for example at 404. The WTRU may monitor the first search space set 406, for example a subset of the first search space set (e.g., N/2 PDCCH candidates) and/or an additional search space set 408 (e.g., N/2 PDCCH candidates). For example the WTRU may monitor the first search space set 406, for example a subset of the first search space set (e.g., N/2 PDCCH candidates) and/or an additional search space set 408 (e.g., N/2 PDCCH candidates) starting at start time (e.g., Tₛₜₐᵣₜ). The WTRU may continue to monitor the first search space set (e.g., at 410 and/or 414) (e.g., a subset of the first search space set (e.g., N/2 PDCCH candidates) and/or an additional search space set (e.g., at 412 and/or 416) (e.g., N/2 PDCCH candidates), for example until the start time (e.g., Tₛₜₐᵣₜ) + the time duration (e.g., D). The WTRU may (e.g., then/after the start time + the time duration) continue to monitor the first search space set 418 (e.g., only), for example for N PDCCH candidates.

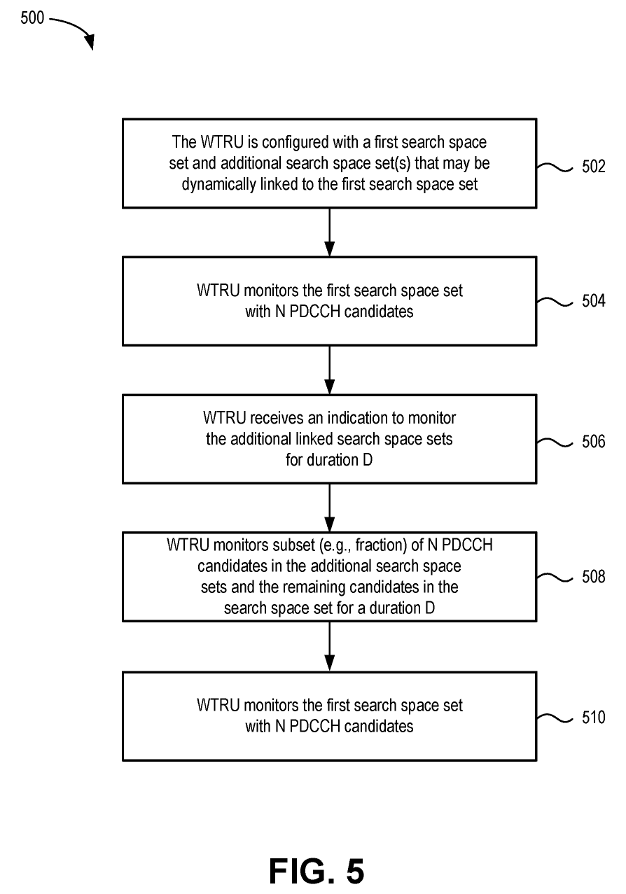

FIG. 5 is an example procedure 500 of WTRU monitoring of one or more search space sets. At 502 the WTRU may be configured with a first search space set with a first number of PDCCH candidates. Additionally, or alternatively, at 502 the WTRU may be configured with additional search space set(s), for example that can be dynamically linked to the first search space set. The linked search space sets may be used for PDCCH repetition(s).

At 504 the WTRU may monitor the first search space set (e.g., for a first occurrence), for example using the first number of PDCCH candidates. At 506 the WTRU receives an indication in the first search space set that additional search space sets are linked to the first search space set, for example in a DCI. Additionally, or alternatively, the indication (e.g., at 506) may include an indication of one or more of additional search space set(s) ID(s) linked to the first search space set, a subset (e.g., fraction) of the first number of PDCCH candidates to monitor in the additional search space set(s) (e.g., half of the first number of PDCCH candidates to be monitored in the additional search space set), a start time (e.g., Tₛₜₐᵣₜ) where the WTRU should start monitoring the additional search space set(s), and/or a time duration (e.g., D) of how long the WTRU should monitor the additional search space set(s).

At 508 the WTRU may start monitoring the subset (e.g., fraction) of the first number of PDCCH candidates in the indicated additional search space set(s), for example from Tₛₜₐᵣₜ to Tₛₜₐᵣₜ +D. The WTRU may monitor the remaining PDCCH candidates in the first search space set, for example from Tₛₜₐᵣₜ to Tₛₜₐᵣₜ +D (e.g., first number of PDCCH candidates minus the subset/fraction of the first number of PDCCH candidates). The WTRU may receive a DCI using at least one of a PDCCH candidate in the first search space set and/or a PDCCH candidate repetition in a linked additional search space set. The WTRU may stop monitoring the additional search space sets, for example at Tₛₜₐᵣₜ+D. At 510 the WTRU may monitor the first search space set using the first number of PDCCH candidates, for example starting from Tₛₜₐᵣₜ+D.

1. A wireless transmit/receive unit (WTRU) comprising:
a processor configured to:
receive configuration information comprising an indication of a first search space set and a second search space set, the first search space set indicating first physical downlink control channel (PDCCH) candidates and the second search space set indicating second PDCCH candidates;
monitor at least one of the first PDCCH candidates indicated by the first search space set;
receive an indication that the second search space set is linked to the first search space set in one or more of downlink control information (DCI) or a medium access control (MAC) transmission;
monitor at least one of the second PDCCH candidates indicated by the second search space set based on the indication that the second search space set is linked to the first search space set; and
receive DCI via one or more of the at least one of the first PDCCH candidates or the at least one of the second PDCCH candidates.

2. The WTRU of claim 1, wherein the indication that the second search space set is linked to the first search space set comprises an indication of a subset of the second PDCCH candidates, and wherein the processor configured to monitor the at least one of the second PDCCH candidates indicated by the second search space set comprises the processor being configured to monitor the subset of the second PDCCH candidates.

3. The WTRU of claim 1, wherein the indication that the second search space set is linked to the first search space set comprises an indication of a start time and a time duration, and wherein the processor configured to monitor the at least one of the second PDCCH candidates indicated by the second search space set comprises the processor being configured to monitor the at least one of the second PDCCH candidates indicated by the second search space set at the start time and for the time duration.

4. The WTRU of claim 3, wherein the processor is configured to:
stop monitoring the at least one of the second PDCCH candidates indicated by the second search space set after the time duration; and
monitor the at least one of the first PDCCH candidates indicated by the first search space set after the time duration.

5. The WTRU of claim 1, wherein the indication that the second search space set is linked to the first search space set comprises an identifier of the second search space set, and wherein the processor is configured to determine that the second search space set is linked to the first search space set based on the identifier of the second search space set.

6. The WTRU of claim 1, wherein the first search space set is linked to the second search space set and to a third search space set, the third search space set indicating third PDCCH candidates, wherein the second PDCCH candidates comprise a first subset of repeated first PDCCH candidates and the third PDCCH candidates comprise a second subset of repeated PDCCH candidates.

7. The WTRU of claim 1, wherein the WTRU is preconfigured with a configuration indicating that the first search space set is linked to a third search space set, and wherein the indication that the second search space set is linked to the first search space set comprises an indication to change the configuration to link the first search space set with the second search space set.

8. A method performed by a wireless transmit/receive unit (WTRU), the method comprising:
receiving configuration information comprising an indication of a first search space set and a second search space set, the first search space set indicating first physical downlink control channel (PDCCH) candidates and the second search space set indicating second PDCCH candidates;
monitoring at least one of the first PDCCH candidates indicated by the first search space set;
receiving an indication that the second search space set is linked to the first search space set in one or more of downlink control information (DCI) or a medium access control (MAC) transmission;
monitoring at least one of the second PDCCH candidates indicated by the second search space set based on the indication that the second search space set is linked to the first search space set; and
receiving DCI via one or more of the at least one of the first PDCCH candidates or the at least one of the second PDCCH candidates.

9. The method of claim 8, wherein the indication that the second search space set is linked to the first search space set comprises an indication of a subset of the second PDCCH candidates, and wherein monitoring the at least one of the second PDCCH candidates indicated by the second search space set comprises monitoring the subset of the second PDCCH candidates.

10. The method of claim 8, wherein the indication that the second search space set is linked to the first search space set comprises an indication of a start time and a time duration, and wherein monitoring the at least one of the second PDCCH candidates indicated by the second search space set comprises monitoring the at least one of the second PDCCH candidates indicated by the second search space set at the start time and for the time duration.

11. The method of claim 10, comprising:
stopping monitoring the at least one of the second PDCCH candidates indicated by the second search space set after the time duration; and
monitoring the at least one of the first PDCCH candidates indicated by the first search space set after the time duration.

12. The method of claim 8, wherein the indication that the second search space set is linked to the first search space set comprises an identifier of the second search space set, and wherein the method comprises determining that the second search space set is linked to the first search space set based on the identifier of the second search space set.

13. The method of claim 8, wherein the first search space set is linked to the second search space set and to a third search space set, the third search space set indicating third PDCCH candidates, wherein the second PDCCH candidates comprise a first subset of repeated first PDCCH candidates and the third PDCCH candidates comprise a second subset of repeated PDCCH candidates.

14. The method of claim 8, wherein the WTRU is preconfigured with a configuration indicating that the first search space set is linked to a third search space set, and wherein the indication that the second search space set is linked to the first search space set comprises an indication to change the configuration to link the first search space set with the second search space set.

15. A base station comprising:
a processor configured to:
send configuration information to a wireless transmit/receive unit (WTRU), the configuration information comprising an indication of a first search space set and a second search space set, the first search space set indicating first physical downlink control channel (PDCCH) candidates and the second search space set indicating second PDCCH candidates;
send an indication to the WTRU in one or more of downlink control information (DCI) or a medium access control (MAC) transmission, the indication indicating that the second search space set is linked to the first search space set; and
send DCI via one or more of the at least one of the first PDCCH candidates or the at least one of the second PDCCH candidates.

16. The base station of claim 15, wherein the indication that the second search space set is linked to the first search space set comprises an indication of a subset of the second PDCCH candidates.

17. The base station of claim 15, wherein the indication that the second search space set is linked to the first search space set comprises an indication of a start time and a time duration associated with monitoring the at least one of the second PDCCH candidates indicated by the second search space set.

18. The base station of claim 15, wherein the indication that the second search space set is linked to the first search space set comprises an identifier of the second search space set.

19. The base station of claim 15, wherein the first search space set is linked to the second search space set and to a third search space set, the third search space set indicating third PDCCH candidates, wherein the second PDCCH candidates comprise a first subset of repeated first PDCCH candidates and the third PDCCH candidates comprise a second subset of repeated PDCCH candidates.

20. The base station of claim 15, wherein the processor is configured to send the indication that the second search space set is linked to the first search space set in one or more of a DCI or a medium access control (MAC) transmission.
